(19) United States
(12) Patent Application Publication
(10) Pub. No.: US 2023/0008905 A1
(43) Pub. Date: Jan. 12, 2023

(54) SYSTEM AND METHOD FOR AUTOMATICALLY GENERATING AN OPTIMIZED BUILDING STRUCTURE DESIGN

(71) Applicant: Lendlease Digital IP Pty Limited, Barangaroo NSW (AU)

(72) Inventor: Sindu S. Satasivam, Sydney NSW (AU)

(21) Appl. No.: 17/369,373

(22) Filed: Jul. 7, 2021

(51) Int. Cl. G06F 30/20; G06F 30/13

(52) U.S. Cl. CPC G06F 30/20; G06F 30/13; G06F 2111/16

(57) ABSTRACT

The present approach automatically generates an optimized building structure design given a set of building design parameters including a specified interior layout. The generated building structure design determines floor plate sizing, beam sizing, column sizing, any needed lateral system, and connectors between the determined building element, which are then displayed to the building structure designer for review and which facilitates customization as desired by the building structure designer. Some or all of this process can then be repeated when building design parameters are changed thereby facilitating automated and iterative building structure design as differing design parameters and resulting optimized building structure designs are considered.

### FIELD OF THE INVENTION

The present invention relates generally to generating a building structure design.

### BACKGROUND OF THE INVENTION

The process of designing a building structure has traditionally been a somewhat ad-hoc process. The process typically starts with a chosen building site or location along with some building design parameters such as building dimensions (e.g., width, or length if considered from the building edge or end), height and/or number of stories for a building with multiple stories, and defined interior spaces (e.g., living spaces, kitchens, bedrooms, bathrooms, etc.). A building structure designer must then specify the various elements of the building structure, which typically includes floor plate sizing, beam sizing, column sizing, any needed lateral system, and sizing of connectors between each of these elements. As can be imagined, this can take some time, particularly if later design changes are to be made, and typically requires specialized knowledge of a professional building structure designer (also known in the art as a structural engineer) who must take into account a significant number of building design elements and factors.

Of course, this process of designing a building structure can be fairly straightforward when the specified building design parameters are themselves simple. For example, specifying a one story building of a limited length/width can be an almost trivial building structure design process. However, with a larger building (e.g., multiple floors, overall dimensions, etc.) and a greater number and variety of desired interior units, the building structure design process can become much more complex.

It is for this reason that building structure designers, who may use various design tools such as Computer-Aided Design and Computer-Aided Manufacturing (“CAD/CAM”) tools, still primarily follow an ad hoc, manual (i.e., mental) process of designing a building structure in order to meet all of the specified building design elements while still ensuring structural integrity of the building and each of its elements. In the typical known process, an experienced building structure designer simply chooses each building element based on past experience either already knowing that it will meet the structural integrity requirements or, if uncertain, tests that choice to ensure it meets structural integrity requirements and, if not, then simply chooses a larger or higher quality/cost element. This typically results in what is known as “over-spec'ing” the various building structural design elements (i.e., specifying building structure design elements that are of a higher specification and/or higher quality/cost than required to meet the structural integrity requirements) because it takes too much time and effort (which translates to cost) for the building structure designer to incrementally test each element to ensure otherwise.

Further, as can be imagined, such a manual process can take quite some time and is not easily or quickly revised should one wish to change some of the specified building design elements or consider alternative choices. For example, after the building structure designer has painstakingly designed a building structure to meet the various specified building design elements and provide a structurally sound building structure design, should a different building element be desired, then the building structure designer most likely will have to revisit many of the steps taken in the manual process in order to prepare a revised building structure design, essentially starting over in the building structure design process, a costly and time-consuming endeavor.

What is needed, therefore, is an automated approach to generating a building structure design given a set of specified building design parameters. A further need is for such an automated approach to generate an optimized building structure design (i.e., one that meets structural integrity requirements without over-spec'ing structural design elements). A further need is for such an automated approach to incorporate changes in the specified building parameters while continuing to generate a building structure design in a timely and cost-effective manner.

### SUMMARY OF THE INVENTION

One embodiment discloses a method for generating an optimized building structure design, the method comprising: generating, by a building structure design generator module, a wireframe grid of the building structure being designed; determining, by the building structure design generator module, sizing of specified building floor plates for the building structure being designed, wherein determining specified building floor plates for the building structure being designed comprises: obtaining the specified floor plate type; determining that the specified floor plate type is a ribdeck floor plate type; iterating through each permutation of available ribdeck floor plate types thereby determining viable permutations based on structural limits of each; obtaining a primary driver of the specified floor plate type; sorting the viable permutations of available ribdeck floor plate types according to the obtained primary driver of the specified floor plate type; and, selecting a highest ranked of the sorted viable permutations of available ribdeck floor plate types as an optimum ribdeck floor plate type; determining, by the building structure design generator module, sizing of beams for the building structure being designed; determining, by the building structure design generator module, sizing of columns for the building structure being designed; determining, by the building structure design generator module, any needed lateral system for the building structure being designed; and, determining, by the building structure design generator module, connectors between each of the determined floor plates, beams, columns, and any needed lateral system for the building structure being designed.

In a further embodiment, the method further comprises displaying, by a display and customization module, the building structure being designed.

Another embodiment discloses a system for generating an optimized building structure design, the system comprising: a building structure design generator module configured to: generate a wireframe grid of the building structure being designed; determine sizing of specified building floor plates for the building structure being designed by being configured to: obtain the specified floor plate type; determine that the specified floor plate is a ribdeck floor plate type; iterate through each permutation of available ribdeck floor plate types thereby determining viable permutations based on structural limits of each; obtain a primary driver of the specified floor plate type; sort the viable permutations of available ribdeck floor plate types according to the obtained primary driver of the specified floor plate type; and, select a highest ranked of the sorted viable permutations of available ribdeck floor plate types as the optimum ribdeck floor plate type; determine sizing of beams for the building structure being designed; determine sizing of columns for the building structure being designed; determine any needed lateral system for the building structure being designed; and, determine connectors between each of the determined floor plates, beams, columns, and any needed lateral system for the building structure being designed.

In a further embodiment, the system further comprises a building structure design generator module configured to display the building structure being designed.

### BRIEF DESCRIPTION OF THE DRAWINGS

FIG. 1 is a block diagram of a Building Structure Design Generation System according to one embodiment of the present approach.

FIG. 2 is a flowchart of a process of automatically generating a building structure design according to one embodiment of the present approach.

FIG. 3 is a flowchart of a more detailed example of generating a wireframe grid according to one embodiment of the present approach.

FIG. 4 is an example two-dimensional wireframe grid generated according to one embodiment of the present approach.

FIG. 5 is a flowchart of a more detailed example of determining floor plate sizing, according to one embodiment of the present approach.

FIG. 6 is a flowchart of one method of determining optimum ribdeck floor plate sizing, according to one embodiment of the present approach.

FIG. 7 is a table of viable ribdeck floor plate sizing, according to one embodiment of the present approach.

FIG. 8 is a table of sorted, viable ribdeck floor plate sizing, according to one embodiment of the present approach.

### DETAILED DESCRIPTION OF THE INVENTION

A method and apparatus is disclosed herein for automatically generating an optimized building structure design given a set of building design parameters including a specified interior layout.

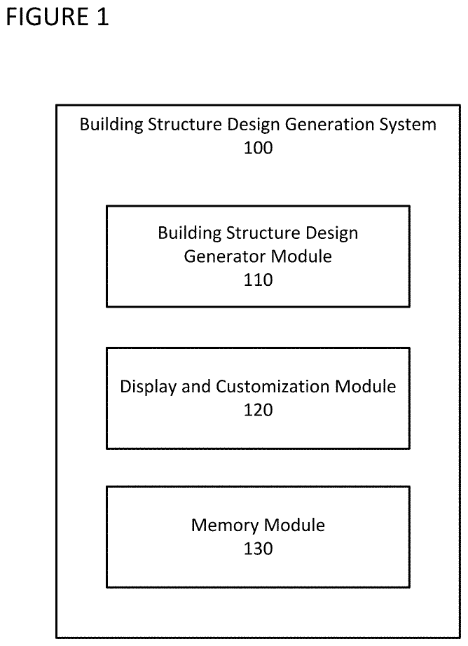

Referring now to the system diagram of FIG. 1, a Building Structure Design Generation System 100 is shown comprising a Building Structure Design Generator Module 110, a Display and Customization Module 120, and a Memory Module 130. In one embodiment, Building Structure Design Generation System 100 is a computing system (e.g., a processor) in which Building Structure Design Generator Module 110, and Display and Customization Module 120 are computing modules (software, hardware or some combination thereof), and Memory Module 130 is operating and/or storage memory for use by the computing system.

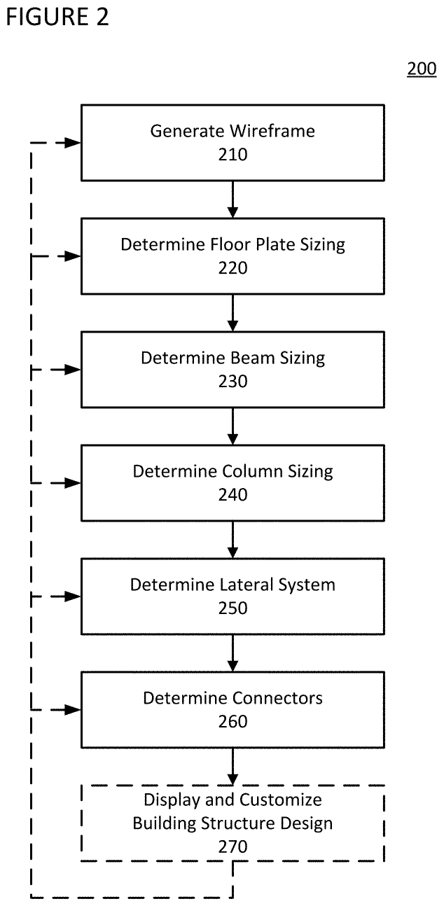

In one embodiment, generating a building structure design uses specified building parameters. Using this information, referring now to FIG. 2, a method 200 for automatically generating an optimized building structure design is shown in flowchart form according to one embodiment. With this method, in step 210, Building Structure Design Generator Module 110 of FIG. 1 generates a wireframe grid, which is a two or three dimensional skeletal outline of the building structure being designed, as explained further elsewhere herein. Continuing with this method, in step 220, Building Structure Design Generator Module 110 of FIG. 1 determines sizing of specified building floor plates for the building structure design, as explained further elsewhere herein.

Continuing with this method, in step 230, Building Structure Design Generator Module 110 of FIG. 1 determines sizing of beams for the building structure design. In one embodiment, beam sizing is determined by incrementing from small beams to large beams until a beam size is found that meets a structural integrity test (such structural integrity tests can be performed using formulas known in the art). In a further embodiment, increasing the depth of beams is prioritized over width of beams (i.e., depth of beams is increased before width of beams is increased to determine the smallest beam size that meets the structural integrity test). According to this further embodiment, a minimum (i.e., smallest available) beam width and minimum (i.e., smallest available) beam depth is set and then beam depth is incrementally increased as needed to determine the smallest beam size that meets the structural integrity test. If the maximum (i.e., largest available) beam depth and minimum (i.e., smallest available) beam width still does not meet the structural integrity test then the minimum (smallest available) beam depth is again set and the next larger available beam width is set and then beam depth is again incrementally increased as needed to determine the smallest beam size that meets the structural integrity test. In one embodiment, material grade of beams is also incremented from lowest available material grade to highest available material grade for each increment of beam sizing when testing for structural integrity thereby also determining a lowest cost beam as the optimum beam size. This iterative process continues to determine the smallest beam size that meets the structural integrity test.

Continuing with this method, in step 240 Building Structure Design Generator Module 110 of FIG. 1 determines sizing of columns for the building structure design. In one embodiment, columns are placed on the nodes of the wireframe grid generated in step 210, and column sizing is determined by incrementing from minimum to maximum column sizing (based on column width, column depth, or both) until a column size is found that meets a structural integrity test (such structural integrity tests can be performed using formulas known in the art). In one embodiment, material grade of columns is also incremented from lowest available material grade to highest available material grade for each increment of column sizing when testing for structural integrity thereby also determining a lowest cost column as the optimum column size. In a further embodiment applicable to multistory buildings, larger column sizes can be determined for lower building floors and smaller column sizes can be determined for upper building floors. In a still further embodiment applicable to multistory buildings determined column sizing can vary for each floor or the same column sizing can be determined for multiple floors with a number of lower building floors being determined to have the same larger column size while a number of upper building floors being determined to have the same smaller column size and, in a yet further embodiment, intermediate building floors being determined to have columns sized between the larger columns of the lower floors and the smaller columns of the upper floors. Such determinations can be based on any known or desirable factor such as building uniformity (where all columns are determined to be the same size), reducing materials cost (either because smaller columns cost less than larger columns or because of possible quantity discounts due to ordering more of the same size columns), simply the local availability of columns and column materials, etc.

Continuing with this method, in step 250 Building Structure Design Generator Module 110 determines any needed lateral system for the building structure design. As is known in the art, some buildings need bracing in addition to that provided by the building's central core (i.e., elevators, stairwells, etc.) to counteract lateral forces (e.g., wind, earthquakes, etc.) that may be applied to the building. In one embodiment, determining any needed lateral system is performed by calculating static and applied loads onto the building and calculating interstory drift of the building, all according to processes and techniques known in the art.

Continuing with this method, in step 260 Building Structure Design Generator Module 110 determines connectors to be used between the other determined elements for the building structure design. Determined elements include, for example, floor plates, beams, columns, any needed lateral system, etc., so the determined connectors include those that connect those different elements. In one embodiment, forces applied to each connector to be located between each of the determined elements is calculated to determine the minimum size or lowest cost connector needed in each of those connectors. In one embodiment, for each connector to be located between each of the determined elements, the forces being applied to that connector are calculated in order to determine the minimum size or lowest cost connector that meets a structural integrity test (such structural integrity tests can be performed using formulas known in the art).

This method continues, in optional step 270, where Display and Customization Module 120 displays on a display device (not shown) to the building structure designer the generated building structure design, which in one embodiment comprises the floor plates, beams, columns, any needed lateral system, and connectors determined in steps 220 through 260, and facilitates customization of the generated building structure design as desired by the designer.

In a further embodiment, also in optional step 270, Display and Customization Module 120 displays on the display device to the building structure designer any or all of the calculations, determinations and selections made according to the present approach. In various embodiments, this can include for example, display of the material properties associated with the material grade (taken from either supplier information or design codes) of the selected structural elements, display of the size of the selected structural elements, display of the calculated applied loads, display of the calculated geometric properties of selected structural elements, display of the calculations of the structural integrity tests showing the formulas known in the art and the results of each along with design codes or guide referencing the formulas, display of the calculated utilization factors showing selected structural elements passing the structural integrity tests, and display of the governing modes of failure (i.e., the mechanism that will cause the selected structural elements and/or optimized structural design to fail).

Displaying some or all of these various determinations, formulas and/or results ensures the building structure designer can follow the calculations of the structural integrity tests and verify a valid solution is being provided. Such display also allows the building structure designer to trace the selected structural elements and solved solutions to specific design clauses, which can be important for calculation review and traceability of structural integrity tests. Such display also gives the building structure designer confidence that the selected structural elements and solved solution is valid and, further, provides information that the building structure designer can use to customize the design if so desired (e.g., changing material grades to cause generation of a different solution) and also makes it easier for the building structure designer to see how customization will influence the resulting building structure thereby improving the building structure designer's ability to direct and control the generation of the optimized building structure.

It is to be understood that any or all of the above processes performed by the corresponding modules shown in the Building Structure Design Generation System 100 of FIG. 1, and the generated intermediate and/or final results of each, as well as the specified building parameters, can be stored in Memory Module 130 thereof, in a given implementation of the present approach.

It is to be further understood in light of the teachings herein that any part or all of the automated process of flowchart 200 can be repeated as needed to accommodate changes in the specified building parameters or design choices. Thus, after the system and method described herein has automatically generated one building structure design based on one set of specified building parameters, the system and method can automatically generate another building structure design based on a specified different set of building parameters and/or design choices. For example, the present approach can be used to automatically generate a different building structure design by specifying different design choices or different structure design presets as described elsewhere herein. This means, as indicated by the dashed lines from step 270 to steps 210 through 260, that the present automated approach can be performed iteratively as different building parameters and/or design choices are considered.

Such iterative processing of the present approach thus provides for essentially real-time generation and evaluation of different building structure designs using alternative building parameters without incurring the time and expense of the ad-hoc, non-optimized, manual building structure design approach presently known.

In accordance with one embodiment, a more detailed example of portions of the present approach will now be explained.

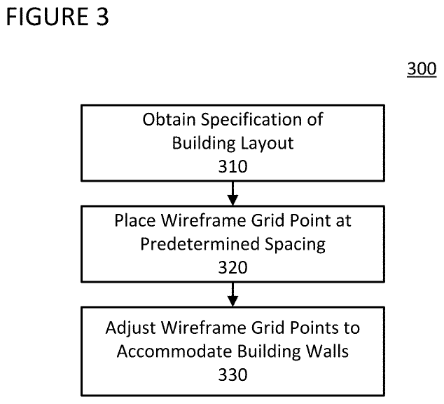

Referring now to FIG. 3, and in accordance with one embodiment, a more detailed example of Building Structure Design Generator Module 110 of FIG. 1 generating a wireframe grid according to step 210 of FIG. 2 is shown as process 300.

In step 310, a building layout, which specifies the location of the building walls, is obtained. In particular, in one embodiment, Building Structure Design Generator Module 110 of FIG. 1 obtains the building layout (i.e., location of exterior and interior building walls as separately determined), which in one embodiment is stored in Memory Module 130 of FIG. 1.

In step 320, a wireframe grid point, also referred to herein as a node, is placed at predetermined spacing (e.g., every 10 feet) along the wireframe grid.

In step 330, the wireframe grid points are adjusted as needed to ensure they are located within the building walls of the building layout. In particular, in one embodiment, any placed grid point that corresponds to a window or open space in the specified building layout is moved by Building Structure Design Generator Module 110 of FIG. 1 to a location within a wall of the specified building layout or eliminated if the span between neighboring wireframe grid points is short enough to be supported by the other building design elements (floor plate size, beam size, column size, connector, etc.) based on a known maximum span length.

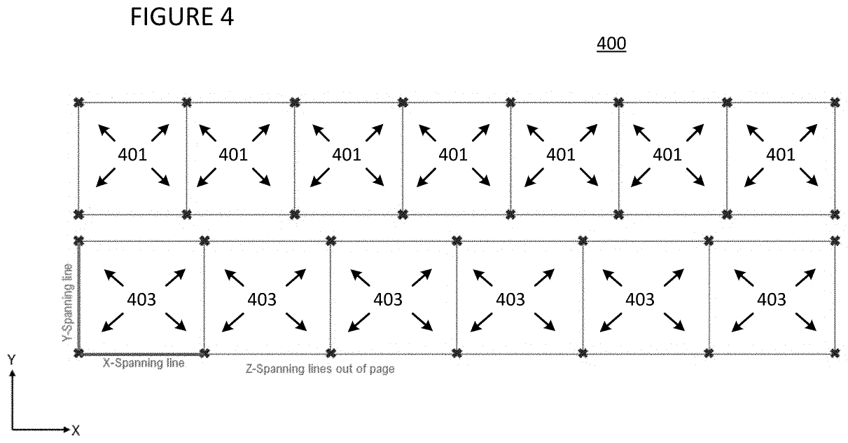

For example, referring now to FIG. 4, an example two-dimensional wireframe grid 400 generated according to one embodiment is shown. In this wireframe grid, for a building comprising units or interior spaces divided by a central corridor as shown, grid points are initially placed at predetermined spacing (e.g., every 10 feet) along the walls of the building layout. However, as can be seen in this example, while wireframe grid points 401 remain at the initial 10 foot spacing, wireframe grid points 403 have been adjusted to correspond to the building walls from the building layout. In particular, in this example, wireframe grid points 403 are located further apart (in this example, in both the X and Y direction) than wireframe grid points 401 due to openings in exterior walls (e.g., windows) or interior walls (e.g., doorways) of that portion of the building layout.

In various embodiments, the wireframe grid points shown in FIG. 4 are stored in Memory Module 130 of FIG. 1 for later use as explained elsewhere herein.

Building Structure Design Generator Module 110 of FIG. 1, having now generated the wireframe grid according to step 210 of FIG. 2, as further explained with reference to FIGS. 3 and 4, continues the process.

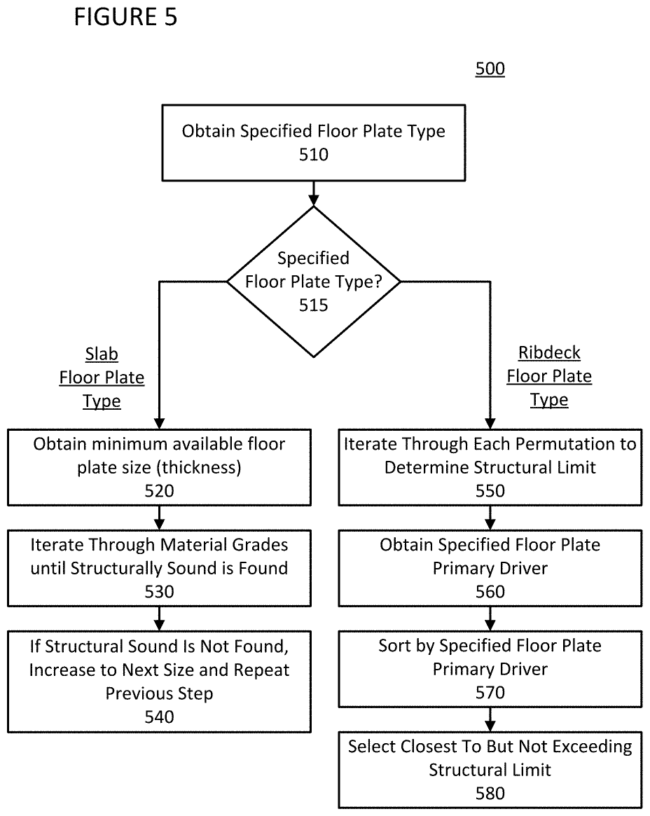

Referring now to FIG. 5, and in accordance with one embodiment, a more detailed example of Building Structure Design Generator Module 110 of FIG. 1 determining floor plate sizing according to step 220 of FIG. 2 is shown as process 500.

In step 510, a specified floor plate type is obtained. Examples of possible floor plate types include slab and ribdeck (also known in the art as a rib deck or rib panel and which, as known in the art, is a horizontal panel supported by underlying vertical ribs), two floor plate types known in the art. In one embodiment, specification of floor plate type can, in various embodiments, be by user input, system administrator or implementer input, or by being hardcoded into Building Structure Design Generation System 100. In one embodiment, Building Structure Design Generator Module 110 of FIG. 1 obtains a specified floor plate type by retrieving it as a stored value from Memory Module 130 of FIG. 1.

For a floor plate type specified to be slab, as determined in step 515, the method 500 of FIG. 5 continues to step 520 where a minimum available floor plate size (e.g., thickness) is obtained. The method then continues to step 530 where a lowest available material grade to a highest available material grade for the obtained available floor plate size (thickness) is tested until a minimum material grade is found that meets structural integrity requirements (such structural integrity tests using formulas known in the art). If no available material grade for the obtained available floor plate size (thickness) meets structural integrity requirements, the process continues to step 540 which obtains a next available floor plate size (thickness) and the method returns to step 530 to again test for meeting structural integrity requirements.

Alternatively, for an obtained floor plate type specified to be ribdeck in step 510, as determined in step 515, the method 500 of FIG. 5 continues to step 550 where each permutation of differing configurations of ribdecks is iterated to determine which configurations are viable based on its structural integrity, using structural integrity formulas known in the art and as explained further elsewhere herein. Examples of possible ribdeck configurations include ribdecks with tall skinny ribs, ribdecks with short wide ribs, ribdecks with a maximum number of limited width ribs, ribdecks with a maximum number of limited depth ribs, and ribdecks with long skinny and limited width ribs, among other possible ribdeck configurations.

The method continues to step 560 where the method obtains a specified floor plate primary driver, as well as secondary driver, tertiary driver, etc., in various embodiments. Examples of possible floor plate drivers include minimum structural floor depth (as that can have an impact on building architecture and service reticulation (i.e., space to fit mechanical services underneath the floor)), minimum structural floor material volume (as that can have an impact on materials cost), minimum number of ribdeck ribs (as that can have an impact on fabrication cost), minimum ribdeck rib clear spacing (as that can have an impact on service reticulation), etc. In one embodiment, specification of floor plate primary (and secondary, tertiary, etc.) driver can, in various embodiments, be by user input, system administrator or implementer input, or by being hardcoded into Building Structure Design Generation System 100. In one embodiment, Building Structure Design Generator Module 110 of FIG. 1 obtains a specified floor plate primary (and secondary, tertiary, etc.) driver by retrieving it as a stored value from Memory Module 130 of FIG. 1.

The method continues to step 570 where the method sorts the viable ribdeck configurations calculated in step 550 according to the specified floor plate primary (and secondary, tertiary, etc.) driver obtained in step 560. The method continues to step 580, which selects as the optimized ribdeck design the highest ranking ribdeck configuration, according to the sorting done in step 570, that is closest to without exceeding the structural limit.

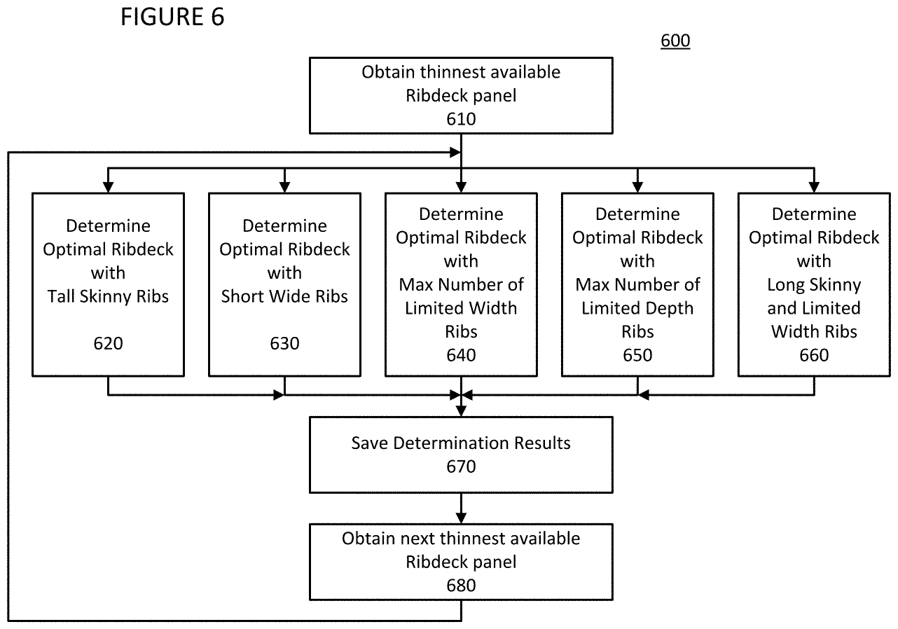

As stated above, each permutation of differing configurations of ribdecks is iterated to determine its structural integrity. This is done to determine optimum ribdeck sizing, which is done in one embodiment, referring now to FIG. 6, according to a method 600, as shown and described.

In step 610, a thinnest available ribdeck panel is obtained. As is known in the art, the panel is the horizontal deck portion of the ribdeck as opposed to the underlying vertical rib portion of the ribdeck. In one embodiment, obtaining a thinnest available ribdeck panel is performed by retrieving that information from memory, which indicates what minimal panel thickness is available (e.g., from local suppliers). For example, using cross-laminated timber (CLT) ribdecks, commercially available panel thickness can be less than 10 centimeters thick.

In step 620, a determination is made for an optimum ribdeck configuration having tall skinny ribs (i.e., increasing the height/depth of the ribs takes precedence over increasing the width of the ribs and, further, the number of ribs is limited as much as possible in arriving at a solution). In this determination, a minimum number of ribs is set, a minimum rib width is set, and a minimum rib height (otherwise referred to herein as depth) is set. This configuration is then tested to determine if it meets or exceeds structural limits for the specified ribdeck using formulas known in the art. If it does not exceed structural limits, then it is considered a viable solution for that ribdeck configuration and, in step 670, is saved in memory as a viable solution for determining optimum ribdeck sizing. If it does exceed structural limits, then the rib height is increased and that configuration is tested as before. This continues until it either does not exceed structural limits, in which case it is a viable solution and is saved in memory, or the rib height reaches a maximum specified rib height. In the latter case, then the rib width is increased, the rib height is again set to a minimum value, and the process of testing successively taller rib heights for that rib width is performed until it either does not exceed structural limits, in which case it is a viable solution and is saved in memory, or the rib width and rib depth reach maximum values. In the latter case, the number of ribs is increased, the rib height and rib width are again set to minimum values, and the process of testing successively taller rib heights and successively wider rib widths is performed until either it does not exceed structural limits, in which case it is a viable solution and is saved in memory, or the rib width, rib depth and number of ribs reach maximum values, in which case there is no viable tall skinny ribs ribdeck configuration optimum solution for this particular panel thickness.

Having saved determined results in step 670, method 600 of FIG. 6 continues to step 680 to obtain the next thinnest available ribdeck panel and then returns to step 620 or, if there is no next thinnest available ribdeck panel method 600 then concludes.

In a somewhat similar and parallel set of operations, in step 630, a determination is made for an optimum ribdeck configuration having short wide ribs (i.e., increasing the width of the ribs takes precedence over increasing the height/depth of the ribs and, further, the number of ribs is limited as much as possible in arriving at a solution). This determination is made in a similar fashion to that of step 620 except that the width of the ribs is increased before the height of the ribs is increased when testing to determine whether a specified ribdeck meets or exceeds structural limits. Step 630, as with step 620, results in determining a viable short wide ribs ribdeck configuration solution, which is saved in step 670, or in determining that no viable short wide ribs ribdeck configuration solution exists for that available panel thickness. Method 600 of FIG. 6 continues to step 680 to determine the next thinnest available ribdeck panel and then returns to step 630 or, if there is no next thinnest available ribdeck panel method 600 then concludes.

Likewise, in a somewhat similar and parallel set of operations, in step 640, a determination is made for an optimum ribdeck configuration with a maximum number of limited width ribs (i.e., increasing the number of ribs takes precedence over increasing the height/depth of the ribs and, further, the width of the ribs is limited as much as possible in arriving at a solution). This determination is made in a similar fashion to that of steps 620 and 630 except that the number of ribs is increased before the height/depth of the ribs is increased before the width of the ribs is increased to determine whether a specified ribdeck meets or exceeds structural limits. Step 640, as with steps 620 and 630, results in determining a viable maximum number of limited width ribs ribdeck configuration solution, which is saved in step 670, or in determining that no viable maximum number of limited width ribs ribdeck configuration solution exists for that available panel thickness. Method 600 of FIG. 6 continues to step 680 to determine the next thinnest available ribdeck panel and then returns to step 640 or, if there is no next thinnest available ribdeck panel method 600 then concludes.

Likewise, in a somewhat similar and parallel set of operations, in step 650, a determination is made for an optimum ribdeck configuration having a maximum number of limited height/depth ribs (i.e., increasing the number of ribs takes precedence over increasing the width of the ribs and, further, the height (aka depth) of the ribs is limited as much as possible in arriving at a solution). This determination is made in a similar fashion to that of steps 620, 630 and 640 except that the number of ribs is increased before the width of the ribs is increased before the height/depth of the ribs is increased to determine whether a specified ribdeck meets or exceeds structural limits. Step 650, as with steps 620, 630 and 640, results in determining a viable maximum number of limited depth ribs ribdeck configuration solution, which is saved in step 670, or in determining that no viable maximum number of limited depth ribs ribdeck configuration solution exists for that available panel thickness. Method 600 of FIG. 6 continues to step 680 to determine the next thinnest available ribdeck panel and then returns to step 650 or, if there is no next thinnest available ribdeck panel method 600 then concludes.

Likewise, in a somewhat similar and parallel set of operations, in step 660, a determination is made for an optimum ribdeck configuration having long skinny and limited width ribs (i.e., increasing the height/depth of ribs takes precedence over increasing the number of the ribs and, further, the width of the ribs is limited as much as possible in arriving at a solution). This determination is made in a similar fashion to that of steps 620, 630, 640 and 650 except that the depth of the ribs is increased before the number of the ribs is increased before the width of ribs is increased to determine whether a specified ribdeck meets or exceeds structural limits. Step 660, as with steps 620, 630, 640 and 650, results in determining a viable long skinny with limited width ribs ribdeck configuration solution, which is saved in step 670, or in determining that no viable long skinny with limited width ribs ribdeck configuration solution exists for that available panel thickness. Method 600 of FIG. 6 continues to step 680 to determine the next thinnest available ribdeck panel and then returns to step 660 or, if there is no next thinnest available ribdeck panel method 600 then concludes.

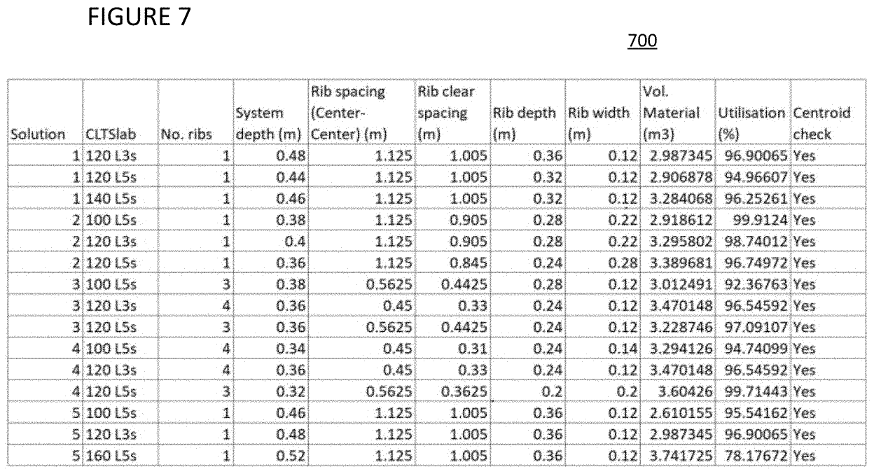

Referring now to FIG. 7, a simplified example of the results of step 550 in FIG. 5, according to the method of FIG. 6, can be seen in a tabular format 700. In this simplified example, each viable solution from step 620 (tall skinny ribs) is shown saved in a row designated “Solution 1,” each viable solution from step 630 (short wide ribs) is shown saved in a row designated “Solution 2,” each viable solution from step 640 (max number of limited width ribs) is shown saved as a row designated “Solution 3,” each viable solution from step 650 (max number of limited depth ribs) is shown saved as a row designated “Solution 4,” and each viable solution from step 660 (long skinny and minimal width ribs) is shown saved as a row designated “Solution 5.”

More particularly, each tall skinny ribdeck configuration Solution 1 is a different viable solution determined in step 620 and saved in step 670 of method 600 of FIG. 6. As can be seen by the first row in table 700 of FIG. 7, the first Solution 1 is a CLT slab 120 L3s (in this example, indicating a thickness of 120 millimeters made up of 3 layers total), having 1 rib, a system depth of 0.48 meters, a rib spacing center-to-center of 1.125 meters, a rib clear spacing of 1.005 meters, a rib depth of 0.36 meters, a rib width of 0.12 meters, a volume of material of 2.987345 square meters, and a utilization factor of 96.90065 percent, as shown in the various columns of the table.

Similarly, as can be seen by the second row in table 700 of FIG. 7, the second Solution 1 is a CLT slab 120 L5s (in this example, indicating a thickness of 120 millimeters made up of 5 layers total), having 1 ribs, a system depth of 0.44 meters, a rib spacing center-to-center of 1.125 meters, a rib clear spacing of 1.005 meters, a rib depth of 0.32 meters, a rib width of 0.12 meters, a volume of material of 2.906878 square meters, and a utilization factor of 94.96607 percent, as shown in the various columns of the table.

Similarly, as can be seen by the third row in table 700 of FIG. 7, the third Solution 1 is a CLT slab 140 L5s (in this example, indicating a thickness of 140 millimeters made up of 5 layers total), having 1 rib, a system depth of 0.46 meters, a rib spacing center-to-center of 1.125 meters, a rib clear spacing of 1.005 meters, a rib depth of 0.32 meters, a rib width of 0.12 meters, a volume of material of 3.284068 square meters, and a utilization factor of 96.25261 percent, as shown in the various columns of the table.

Similarly, example viable solutions for a ribdeck configuration having short wide ribs as determined in step 630 of FIG. 6 can be seen as Solutions 2 in the next three rows of table 700 in FIG. 7.

Similarly, example viable solutions for a ribdeck configuration having a maximum number of limited width ribs as determined in step 640 of FIG. 6 can be seen as Solutions 3 in the subsequent three rows of table 700 in FIG. 7.

Similarly, example viable solutions for a ribdeck configuration having a maximum number of limited depth ribs as determined in step 650 of FIG. 6 can be seen as Solutions 4 in the subsequent three rows of table 700 in FIG. 7.

Similarly, example viable solutions for a ribdeck configuration having long skinny and minimal width ribs as determined in step 660 of FIG. 6 can be seen as Solutions 5 in the last three rows of table 700 in FIG. 7.

Additionally, as is known in the art, it is preferable to have the centroid (i.e., the geometric center) of a ribdeck be located in the ribs rather than in the deck. As such, in a preferred embodiment of the present approach, a further check is made when determining an optimal ribdeck configuration in each of steps 620 through 660 of FIG. 6 to make sure the centroid is in the ribs when determining whether a given solution is a viable one. This is shown in the last column of table 700 of FIG. 7 where each solution is shown as having a “Yes” for centroid check.

Referring again to FIG. 5, this thus completes step 550 of method 500 of FIG. 5, according to one embodiment as shown and described with reference to FIGS. 6 and 7, that is, iterating through each permutation of the ribdeck configurations to determine viable solutions based on structural limits. As explained above, method 500 of FIG. 5 then obtains a specified floor plate primary driver, as well as secondary driver, tertiary driver, etc., in various embodiments, in step 560. Method 500 of FIG. 5 then sorts the resulting viable ribdeck configurations according to the specified floor plate driver(s) to determine an optimum solution.

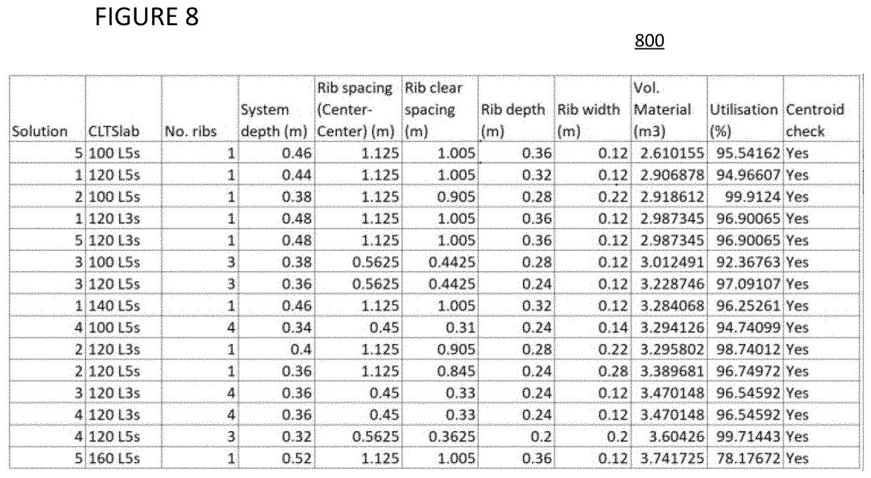

Referring now to FIG. 8, a simplified example of the results of step 570 of FIG. 5 can be seen in a tabular format 800. In this simplified example, the viable solutions shown in table 700 of FIG. 7 have been sorted into table 800 of FIG. 8 according to the specified drivers obtained in step 560 of FIG. 5.

In this simplified example, the specified primary driver is a ribdeck configuration with the least material volume, the specified secondary driver is a ribdeck configuration with the smallest floor system depth, and the specified tertiary driver is a ribdeck configuration with fewest number of ribdeck ribs. It is to be understood that driver ranking can be of any number of drivers and can be of a different ranking than shown in this particular example.

Referring again to FIG. 5, this thus completes step 570 of method 500, according to one embodiment as shown and described with reference to FIGS. 6, 7 and 8, that is, sorting solutions according to specified floor plate configuration driver. As explained above, method 500 of FIG. 5 then, in step 580, selects as the optimum ribdeck configuration the highest ranked driver ribdeck configuration with the highest utilization percentage that does not exceed 100% (in this case, a ribdeck with, first, the lowest material volume, second, the smallest depth, and third, the fewest number of ribs, which in this case is Solution 5 CLT slab 100 L5s, as shown in the first row of sorted results in Table 800 of FIG. 8) thus concluding the process of method 500 of FIG. 5 for a ribdeck specified floor plate type.

Building Structure Design Generator Module 110 of FIG. 1, having now determined floor plate sizing according to step 220 of FIG. 2, as further explained with reference to FIGS. 5 through 8, continues the process by, in step 230 and as explained above, next determining sizing of beams for the building structure design.

As has now been explained, the present approach automatically generates a building structure design given a set of building design parameters. Further, the present approach can automatically generate a different building structure design given a different set of building design parameters and can do so without necessarily having to repeat all of the operations performed when generating a previous building structure design. Still further, the present approach can automatically generate a different building structure design given a different preset selection. This provides the ability to realize different building structure designs in essentially real-time thus allowing alternatives to be considered. Further still, the present approach can be performed not only by an experienced building structure designer but also by an inexperienced or non-professional person to design an optimized building structure design.

The primary example described herein is the generation of a building structure design for an apartment building. However, it is to be understood in light of the teachings herein that the present approach is equally applicable to any type of building that is to contain a mix of different unit types with a defined width (or length). As such, the present approach can be used to generate a building structure design for a condominium building, an office building, a hotel, a hospital, a parking structure, or any other residential or commercial structure.

The disclosed system and method has been explained above with reference to several embodiments. Other embodiments will be apparent to those skilled in the art in light of this disclosure. Certain aspects of the described method and apparatus may readily be implemented using configurations or steps other than those described in the embodiments above, or in conjunction with elements other than or in addition to those described above. It will also be apparent that in some instances the order of steps described herein may be altered without changing the result or performance of all of the described steps.

There may be a single computing system, server or processor, or multiple computing systems, servers or processors to implement the system and perform the different functions described herein. One of skill in the art will appreciate how to determine which and how many of each will be appropriate for a specific intended application.

Further, it should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. It should be noted that the order of the steps of the methods described herein may be altered and still be within the scope of the disclosure.

These and other variations upon the embodiments described and shown herein are intended to be covered by the present disclosure, which is limited only by the appended claims.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for generating an optimized building structure design, the method comprising:
generating, by a building structure design generator module, a wireframe grid of the building structure being designed;
determining, by the building structure design generator module, sizing of specified building floor plates for the building structure being designed, wherein determining specified building floor plates for the building structure being designed comprises:
obtaining the specified floor plate type;
determining that the specified floor plate type is a ribdeck floor plate type;
iterating through each permutation of available ribdeck floor plate types thereby determining viable permutations based on structural limits of each;
obtaining a primary driver of the specified floor plate type;
sorting the viable permutations of available ribdeck floor plate types according to the obtained primary driver of the specified floor plate type; and,
selecting a highest ranked of the sorted viable permutations of available ribdeck floor plate types as an optimum ribdeck floor plate type;
determining, by the building structure design generator module, sizing of beams for the building structure being designed;
determining, by the building structure design generator module, sizing of columns for the building structure being designed;
determining, by the building structure design generator module, any needed lateral system for the building structure being designed; and,
determining, by the building structure design generator module, connectors between each of the determined floor plates, beams, columns, and any needed lateral system for the building structure being designed.

2. The method of claim 1, further comprising displaying, by a display and customization module, the building structure being designed.

3. The method of claim 2, further comprising displaying, by the display and customization module, calculations, determinations and/or selections made for the building being designed.

4. The method of claim 1 wherein generating the wireframe grid of the building structure being designed, comprises:
obtaining a building layout of the building being designed;
placing grid points at predetermined spacing along the obtained building layout; and,
adjusting the placed grid points as needed to ensure they are located within building walls of the building layout.

5. The method of claim 1 wherein the permutations of available ribdeck floorplate types comprise ribdecks with tall skinny ribs, ribdecks with short wide ribs, ribdecks with a maximum number of limited width ribs, ribdecks with a maximum number of limited depth ribs, and ribdecks with long skinny and limited width ribs.

6. The method of claim 1 wherein determining sizing of beams for the building structure being designed comprises incrementing from small beams to large beams until a beam size is found that meets a structural integrity test.

7. The method of claim 6 wherein incrementing from small beams to large beams further comprises incrementing depth of beams before incrementing width of beams.

8. The method of claim 7 wherein incrementing from small beams to large beams further comprises incrementing from a lowest available material grade to a highest available material grade for each increment of beam sizing.

9. The method of claim 1 wherein determining sizing of columns for the building structure being designed comprises incrementing from small columns to large columns until a column size is found that meets a structural integrity test.

10. The method of claim 9 wherein incrementing from small columns to large columns further comprises incrementing from a lowest available material grade to a highest available material grade for each increment of column sizing.

11. The method of claim 1 wherein determining any needed lateral system for the building structure being designed is performed by calculating static and applied loads onto the building being designed and calculating interstory drift of the building.

12. The method of claim 1 wherein determining connectors for the building structure comprises incrementing from a minimum size connector to a maximum size connector until a structural integrity test is met.

13. The method of claim 1 wherein determining connectors for the building structure comprises incrementing from a lowest cost connector to a highest cost connector until a structural integrity test is met.

14. A system for generating an optimized building structure design, the system comprising:
a building structure design generator module configured to:
generate a wireframe grid of the building structure being designed;
determine sizing of specified building floor plates for the building structure being designed by being configured to:
obtain the specified floor plate type;
determine that the specified floor plate is a ribdeck floor plate type;
iterate through each permutation of available ribdeck floor plate types thereby determining viable permutations based on structural limits of each;
obtain a primary driver of the specified floor plate type;
sort the viable permutations of available ribdeck floor plate types according to the obtained primary driver of the specified floor plate type; and,
select a highest ranked of the sorted viable permutations of available ribdeck floor plate types as the optimum ribdeck floor plate type;
determine sizing of beams for the building structure being designed;
determine sizing of columns for the building structure being designed;
determine any needed lateral system for the building structure being designed; and,
determine connectors between each of the determined floor plates, beams, columns, and any needed lateral system for the building structure being designed.

15. The system of claim 14, further comprising a building structure design generator module configured to display the building structure being designed.

16. The system of claim 15 wherein the building structure design generator module is further configured to display calculations, determinations and/or selections made for the building being designed.

17. The system of claim 14, wherein the permutations of available ribdeck floorplate types comprise ribdecks with tall skinny ribs, ribdecks with short wide ribs, ribdecks with a maximum number of limited width ribs, ribdecks with a maximum number of limited depth ribs, and ribdecks with long skinny and limited width ribs.
